(19) United States
(12) Patent Application Publication
(10) Pub. No.: US 2016/0142521 A1
(43) Pub. Date: May 19, 2016

(54) METHOD AND APPARATUS FOR TRANSMITTING SIGNALLING IN HEADER FIELD

(71) Applicant: Samsung Electronics Co., Ltd., Gyeonggi-do (KR)

(72) Inventor: Mark G. Rison, Cambriddge (GB)

(21) Appl. No.: 14/547,918

(22) Filed: Nov. 19, 2014

(51) Int. Cl. H04L 29/06; H04W 28/06

(52) U.S. Cl. CPC H04L 69/22; H04W 28/06

(57) ABSTRACT

A method, apparatus, and non-transitory computer-readable recording medium for transmitting signalling in a field of a header. The method includes identifying the field of a header; replacing n bits in the field with n signalling bits, where positions in the field replaced by the n signalling bits are contiguous or non-contiguous, and where the n signalling bits and the positions in the field are user-defined; and transmitting the header. The apparatus includes a processor configured to identify a field of a header; a controller configured to replace n bits in the field with n signalling bits, where positions in the field replaced by the n signalling bits are contiguous or non-contiguous, and where the n signalling bits and the positions in the field are user-defined; and a transceiver configured to transmit the header.

### BACKGROUND OF THE INVENTION

1. Field of the Invention

The present invention relates generally to a method and apparatus for transmitting signalling in a field of a header, and more particularly, to transmitting signalling in a field of an IEEE 802.11 MAC header.

2. Description of the Related Art

The Institute of Electrical and Electronics Engineers (IEEE) published a standard (i.e., IEEE 802.11) for connecting wireless stations.

The main components concerning the IEEE 802.11 standard include a Station (STA), an Access Point (AP), a Basic Service Set (BSS) and a Distribution System (DS).

An infrastructure BSS is a wireless network consisting of an AP and zero or more STAs, where a STA in a BSS can communicate through the AP. There are other types of BSS.

The APs of multiple infrastructure BSSs are interconnected by the DS, which allows a STA to move from one BSS to another and, therefore, become mobile.

The IEEE 802.11 standard specifies wireless communication for a Physical (PHY) layer and a Medium Access Control (MAC) layer that communicates up to the Link Control Layer (LCL) of the Open System Interconnection (OSI) model for a communication system.

The components of the IEEE 802.11 standard concern either the PHY layer or the MAC layer, which is a sublayer of the Data Link Layer (DLL) of the OSI model.

The IEEE 802.11 standard uses three main types of frames for communication: data frames, control frames, and management frames.

All frames include a 2 byte Frame Control field, where one byte, or octet, represents 8 binary digits or bits; a 2 byte Duration/Identification (Duration/ID) field; a 6 byte Address 1 field for a receiver's address (e.g., a Destination Address); an optional 6 byte Address 2 field for a transmitter's address (e.g., a Source Address); an optional 6 byte Address 3 field; an optional 2 byte Sequence Control field; an optional 6 byte Address 4 field; an optional 2 byte QoS Control field; an optional 4 byte HT Control field; a variable Frame Body field; and a 4 byte Frame Check Sequence field for error detection.

The bytes before the Frame Body field are referred to as the MAC header.

The Duration/ID field is a 16 bit field used by all frames. There are several forms of the Duration/ID field.

One form of Duration/ID field is used to provide a number indicating a number of microseconds another station must wait before transmitting a signal. This wait period is embodied in the concept of a Network Allocation Vector (NAV).

Another form of a Duration/ID field is in the subtype PS-Poll frame. The most significant two bits of the Duration/ID field are “11.” An STA may save battery power by turning off antennas. A STA that is in a sleep mode may wake up periodically. To ensure that no frames are lost, an awakening STA transmits a PS-Poll frame to retrieve any buffered frames from an AP. Along with this request, the PS-Poll frame includes an Association Identifier (AID) field that indicates to the AP which STA it is. The AID field includes a number in the range from 1 to 2007.

The Frame Control field includes the following fields: a 2 bit Protocol field, a 2 bit Type field, a 4 bit Subtype field, a 1 bit “To DS” field, a 1 bit “From DS” field, a 1 bit “More Fragments” field, a 1 bit Retry field, a 1 bit “Power Management” field, a 1 bit “More Data” field, a 1 bit “Protected Frame” field, and a 1 bit Order field.

The Protocol field indicates the version of the IEEE 802.11 standard being used during a communication. The Type field identifies the type of the frame, where three possible types are data frame, control frame, management frame or extension frame. The Subtype field identifies the subtype of the frame, where each type of frame includes a number of subtypes. The “To DS” field indicates that the frame sent by a non-AP STA is being sent to the DS, where the STA associated with the frame must be associated with an AP. The “From DS” field indicates that a frame is being sent from the DS by the AP, where the STA associated with the frame must be associated with an AP. The “More Fragments” field indicates whether or not there are more data type or management type fragments to follow. The Retry field indicates whether or not a data frame or a management frame is being retransmitted. The “Power Management” field indicates whether the sending STA is in active mode or power-save mode. The “More Data” field indicates to a STA in power-save mode that the AP has more frames to send or that an AP has additional broadcast/multicast frames to send. The “Protected Frame” field indicates whether or not encryption and authentication are used in the frame. The Order field indicates whether received data frames must be processed in order, or whether the frame contains an additional field in the MAC header.

It is proving increasingly difficult to improve spectrum efficiency of a WLAN that observes the IEEE 802.11 standard, because of a lack of unused header fields/values. In addition, IEEE 802.11 headers in which formerly reserved fields/values have been used cannot in general be used so that the modified header will work with a STA that uses a header that has not been similarly modified. That is, a modified header is not generally backward compatible with a STA that does not use the same header.

Some IEEE 802.11 MAC header fields have been modified. For example, the Order bit was effectively redefined in the IEEE 802.11 n/ac standard to be an “extended header used” bit for packets that observe the IEEE 802.11 n/ac standard.

The IEEE 802.11 ac standard placed some MAC information in part of the scrambler information in the PHY layer.

There are no clear choices of bits in the IEEE 802.11 standard to repurpose to improve WLAN spectrum efficiency without introducing cross-layer issues (e.g., MAC signalling in multiple layers).

There is a need for a method and an apparatus that improves WLAN spectrum efficiency without introducing cross-layer issues, while being backward compatible with WLANs that use different signalling schemes.

### SUMMARY OF THE INVENTION

The present invention has been made to address the above-mentioned problems and disadvantages, and to provide at least the advantages described below. Accordingly, an aspect of the present invention provides a method and apparatus for transmitting signalling in a field of a header that improves WLAN spectrum efficiency without introducing cross-layer issues, while being backward compatible with WLANs that use different signalling schemes.

In accordance with an aspect of the present invention, a method of transmitting signalling in a field of a header is provided. The method includes identifying the field of the header; replacing n bits of the field with n signalling bits, where positions in the field replaced by the n signalling bits are contiguous or non-contiguous, and where the n signalling bits and the positions in the field are user-defined; and transmitting the header.

In accordance with another aspect of the present invention, an apparatus for transmitting signalling in a field of a header is provided. The apparatus includes a processor configured to identify the field of the header; a controller configured to replace n signalling bits in the field with n signalling bits, where positions in the field replaced by the n signalling bits are contiguous or non-contiguous, and where the n signalling bits and the positions in the field are user-defined; and a transceiver configured to transmit the header.

In accordance with another aspect of the present invention, a non-transitory computer-readable recording medium is provided. The non-transitory computer-readable recording medium has recorded thereon a program for transmitting signalling in a field of a header, the program, when executed by a computer, causes the computer to perform a method, the method including identifying the field of the header; replacing n bits in the field with n signalling bits, where positions in the field replaced by the n signalling bits are contiguous or non-contiguous, and where the n signalling bits and the positions in the field are user-defined; and transmitting the header.

### BRIEF DESCRIPTION OF THE DRAWINGS

The above and other aspects, features, and advantages of the present invention will be more apparent from the following detailed description, taken in conjunction with the accompanying drawings, in which:

FIG. 1 is an illustration of an IEEE 802.11 MAC header that includes a Duration/ID field;

FIG. 2 is an illustration of a Duration/ID field in an IEEE 802.11 MAC header;

FIG. 3 is an illustration of an IEEE 802.11 MAC header that includes a PS-Poll AID field;

FIG. 4 is an illustration of a PS-Poll AID field in an IEEE 802.11 MAC header;

FIG. 5 is a flowchart of a method of an embodiment of the present invention;

FIG. 6 is a flowchart of a method of an embodiment of the present invention;

FIG. 7 is a flowchart of a method of an embodiment of the present invention;

FIG. 8 is a flowchart of a method of an embodiment of the present invention;

FIG. 9 is a flowchart of a method of an embodiment of the present invention;

FIG. 10 is a flowchart of a method of an embodiment of the present invention; and

FIG. 11 is a schematic block diagram of an apparatus of a station of the present invention.

### DETAILED DESCRIPTION OF EMBODIMENTS OF THE PRESENT INVENTION

Hereinafter, embodiments of the present invention are described in detail with reference to the accompanying drawings. In the following description, specific details such as detailed configuration and components are merely provided to assist the overall understanding of the embodiments of the present invention. Therefore, it should be apparent to those skilled in the art that various changes and modifications of the embodiments described herein may be made without departing from the scope and spirit of the present invention. In addition, descriptions of well-known functions and constructions are omitted for clarity and conciseness. The terms described below are terms defined in consideration of the functions in the present invention, and may be different according to users, intentions of the users, or customs. Therefore, the definitions of the terms should be determined based on the contents throughout this specification.

The present invention may have various modifications and various embodiments, among which embodiments will now be described in detail with reference to the accompanying drawings. However, it should be understood that the present invention is not limited to the embodiments, but the present invention includes all modifications, equivalents, and alternatives with the spirit and the scope of the present invention.

Although the terms including an ordinal number such as first, second, etc. may be used for describing various elements, the structural elements are not restricted by the terms. The terms are only used to distinguish one element from another element. For example, without departing from the scope of the present invention, a first structural element may be referred to as a second structural element. Similarly, the second structural element may also be referred to as the first structural element. As used herein, the term “and/or” includes any and all combinations of one or more associated items.

The terms used herein are merely used to describe specific embodiments and are not intended to limit the present invention. Singular forms are intended to include plural forms unless the context clearly indicates otherwise. In the description, it should be understood that the terms “include” or “have” indicate existence of a feature, a number, a step, an operation, a structural element, parts, or a combination thereof, and do not exclude the existence or probability of addition of one or more other features, numerals, steps, operations, structural elements, parts, or combinations thereof.

Unless defined differently, all terms used herein, which include technical terminologies or scientific terminologies, have the same meaning as that understood by a person skilled in the art to which the present invention belongs. Such terms as those defined in a generally used dictionary are to be interpreted to have the meanings equal to the contextual meanings in the relevant field of art, and are not to be interpreted to have ideal or excessively formal meanings unless clearly defined in the present specification.

Although the following description of the embodiments of the present invention uses terms and names defined in the IEEE 802.11 standard, the present invention is not limited by these terms and names, and is identically applicable to other similar systems.

Bits are herein numbered starting from bit 0, which is the least significant bit (LSB). The most significant bit (MSB) of a 16-bit field, for example, is bit 15. Binary values and fields are shown with the MSB left-most and the LSB right-most.

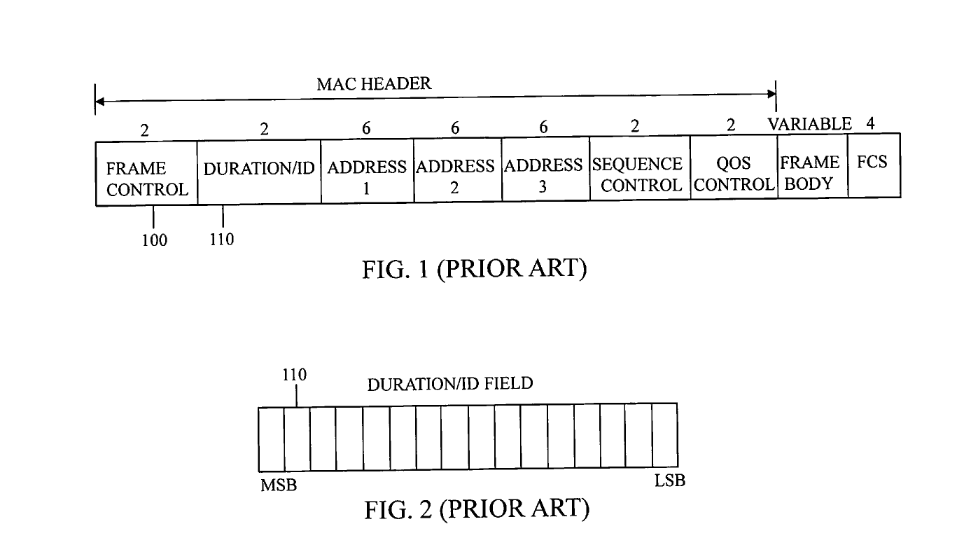

FIG. 1 is an illustration of an IEEE 802.11 MAC header 100 that includes a Duration/ID field 110.

Referring to FIG. 1, an example IEEE 802.11 MAC header 100 is disclosed, where the MAC header includes a plurality of fields, where the number of bytes in each field is indicated. That is, the MAC header 100 includes a Frame Control field, where the Frame Control field includes 2 bytes (i.e., 16 binary digits or bits), a 2 byte Duration/ID field 110, a 6 byte Address 1 field, a 6 byte Address 2 field, a 6 byte Address 3 field, a 2 byte Sequence Control field, and a 2 byte QoS Control field. The MAC header 100 is typically followed by a variable Frame Body field and a 4 byte Frame Check Sequence (FCS) field. However, there are other formats of MAC headers, and the present invention applies to them.

FIG. 2 is an illustration of the Duration/ID field 110 in an IEEE 802.11 MAC header 100.

Referring to FIG. 2, the Duration/ID field 110 includes 2 bytes or 16 bits.

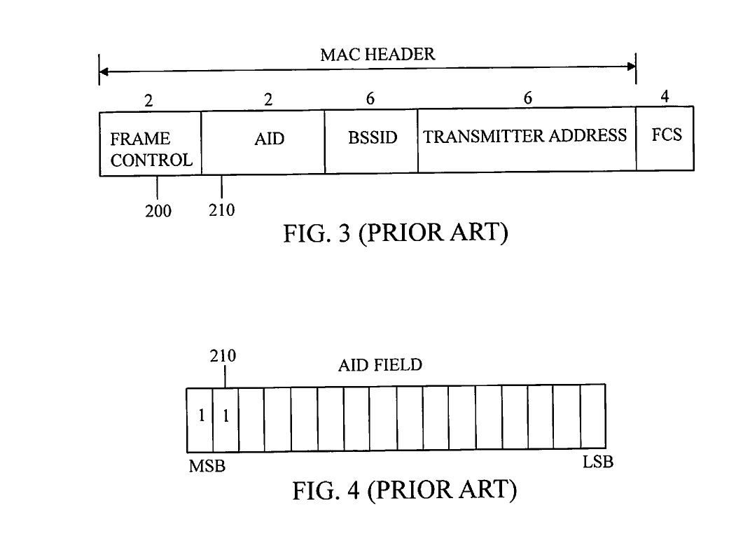

FIG. 3 is an illustration of an IEEE 802.11 MAC header 200 that includes a PS-Poll AID field 210.

FIG. 4 is an illustration of a PS-Poll AID field 210 in an IEEE 802.11 MAC header 200.

Referring to FIG. 4, the PS-Poll AID field 210 includes 2 bytes or 16 bits, where the two MSBs are “11”.

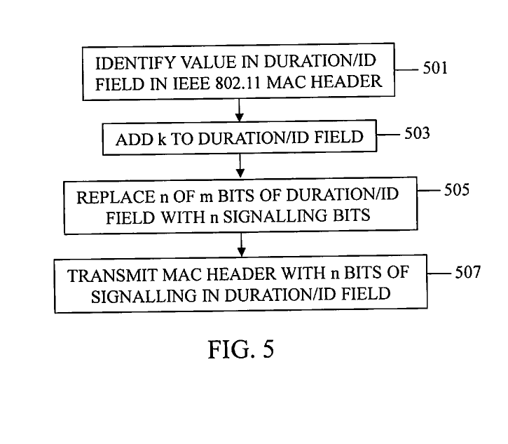

FIG. 5 is a flowchart of a method of an embodiment of the present invention, where a decimal value k is added to a Duration/ID field in an IEEE 802.11 MAC header and n bits of signalling replace n of m bits (e.g., n Least Significant Bits (LSBs)) of the Duration/ID field, where the n bits of signalling are user-defined, where n≦m, where the positions of the n of m bits are user-defined and may be contiguous or not.

Referring to FIG. 5, in step 501, a value stored in a Duration/ID field in an IEEE 802.11 MAC header is identified. For example, if the value stored in the Duration/ID field is a decimal value of 1234 (i.e., a binary value of “0000010011010010”), then in terms of a NAV for the Duration/ID field, the decimal value 1234 represents a time period of 1234 microseconds.

In step 503, a decimal value k is added to the value stored in the Duration/ID field of the IEEE 802.11 MAC header. An example of k is the decimal value 4 (i.e., binary value “100”). For the present example, adding decimal value 4 to decimal value 1234 results in decimal value 1238 (i.e., binary value “0000010011010110”).

In step 505, n signalling bits replace n of m bits of the Duration/ID field, where the n bits of signalling are user-defined, where n≦m, and where the positions of the n of m bits in the Duration/ID field are user-defined. For example, if n is 2 and the 2 signalling bits are “01” and LSBs, then in step 505 in the present example the 2 LSBs of “0000010011010110” are replaced with “01” to result in a binary value “0000010011010101” (i.e., a decimal value 1237), which in terms of a NAV represents 1237 microseconds.

In step 507, the IEEE 802.11 MAC header that includes n signalling bits in the Duration/ID field is transmitted. Such a transmission improves WLAN spectrum efficiency by increasing the amount of signalling that may be transmitted in an IEEE 802.11 MAC header by n bits. Since the increased signalling is contained within one IEEE 802.11 MAC header, which is transmitted in one OSI layer, no cross-layer issues are introduced by the method. In addition, the IEEE 802.11 MAC header with the n additional signalling bits is backward compatible with IEEE 802.11 MAC headers of other WLANs that do not include signalling bits per the present invention if n is chosen appropriately (e.g. n=2).

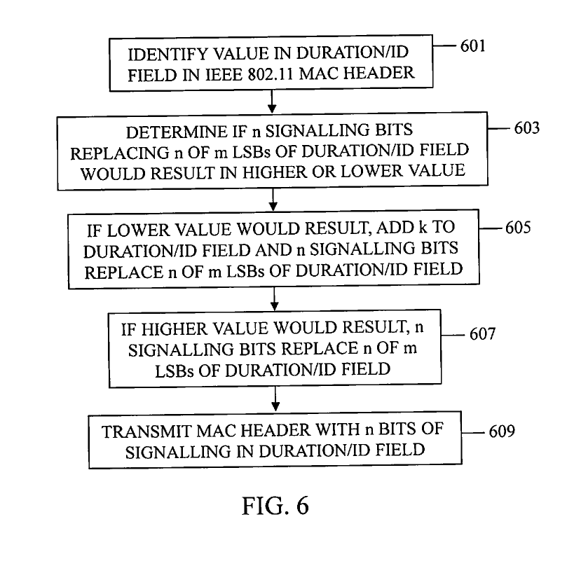

FIG. 6 is a flowchart of a method of an embodiment of the present invention, where n bits of signalling replace n of m Least Significant Bits (LSBs) of a Duration/ID field in an IEEE 802.11 MAC header, depending on how the value of the n bits of signalling compares to the value in the m LSBs of the Duration/ID field, where the n bits of signalling are user-defined, where n≦m, and where the positions of the n of m bits in the Duration/ID field are user-defined and may be contiguous or not.

Referring to FIG. 6, in step 601, a value stored in a Duration/ID field in an IEEE 802.11 MAC header is identified. For example, if the decimal value stored in the Duration/ID field is 1234 (i.e., binary value “0000010011010010”), then in terms of a NAV for the Duration/ID field, decimal value 1234 represents a time period of 1234 microseconds.

In step 603, it is determined if a value of n bits of signalling to replace n of m LSBs of the Duration/ID field of the IEEE 802.11 MAC header increases or decreases the resulting value of the m LSBs of the Duration/ID field as compared to the value of the m LSBs of the Duration/ID field prior to replacing the n bits, where n≦m, where the n bits of signalling are user-defined, and where the positions of the n of m LSBs are user-defined. In a first example, n and m are 2, and the 2 signalling bits to be added to the Duration/ID field are “01.” Therefore, the 2 signalling bits have a decimal value of 1. For the Duration/ID field of “0000010011010010,” the 2 LSBs are “10,” which have a decimal value of 2. Therefore, the value of the 2 bits of signalling (i.e., decimal value 1) is less than the value of the 2 LSBs of the Duration/ID field (i.e., decimal value 2). In a second example, n and m are again 2, and the 2 signalling bits are “11.” Therefore, the 2 signalling bits have a decimal value of 3, which is greater than the decimal value of 2 for the Duration/ID field.

If n bits of signalling replacing n of m LSBs of the Duration/ID field would decrease the value of the m LSBs as compared to the value of the m LSBs prior to n signalling bits replacing n of m LSBs of the Duration/ID field, then in step 605 a decimal value k=2^{m} is added to the decimal value of the Duration/ID field prior the n signalling bits replacing n of m LSBs of the Duration/ID field, and the n signalling bits replacing n of m LSBs of the Duration/ID field, where the n bits of signalling are user-defined, where n≦m, and where the positions of the n of m LSBs are user-defined. An example of a decimal value for k is the decimal value 4 (i.e., binary “10”). For the first example described above, where the decimal value of the n bits of signalling is less than the decimal value of the n LSBs and would decrease the value of the m LSBs of the Duration/ID field (i.e., in this example, m=n), adding 4 to 1234 results in the sum 1238 (or binary “0000010011010110”), and two signalling bits (i.e., “01”) that have a decimal value less than the 2 LSBs of the Duration/ID field replacing the 2 LSBs of “0000010011010110” results in “0000010011010101” (i.e., decimal value 1237), which in terms of a NAV represents 1237 microseconds.

If n bits of signalling replacing n of m LSBs of the Duration/ID field would increase the value of the m LSBs as compared to the value of the m LSBs prior to the n bits of signalling replacing n of m LSBs of the Duration/ID field, then in step 607 the n bits of signalling replace n of m LSBs of the Duration/ID field, where the n bits of signalling are user-defined, where n≦m, and where the positions of the n of m LSBs are user-defined. For the second example described above, where the decimal value of the n bits of signalling is greater than the decimal value of the n LSBs of the Duration/ID field and would increase the value of the m LSBs of the Duration/ID field (i.e., in this example, m=n), two signalling bits (i.e., “11”) that have a decimal value greater than the 2 LSBs of the Duration/ID field replacing the 2 LSBs of “0000010011010110” results in “0000010011010011” (i.e., decimal value 1235), which in terms of a NAV represents 1235 microseconds.

In step 609, the IEEE 802.11 MAC header that includes n signalling bits in the Duration/ID field is transmitted. Such a transmission improves WLAN spectrum efficiency by increasing the amount of signalling that may be transmitted in an IEEE 802.11 MAC header by n bits. Since the increased signalling is contained within one IEEE 802.11 MAC header, which is transmitted in one OSI layer, no cross-layer issues are introduced by the method. In addition, the IEEE 802.11 MAC header with the n additional signalling bits per the present invention is backward compatible with IEEE 802.11 MAC headers of other WLANs that do not include signalling bits per the method of FIG. 6, if n is chosen appropriately (e.g. n=2).

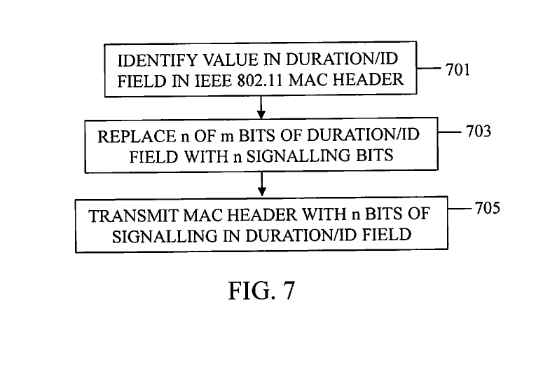

FIG. 7 is a flowchart of a method of an embodiment of the present invention, where n bits of signalling replace n of m bits, where n≦m, (e.g. n LSBs) of a Duration/ID field in an IEEE 802.11 MAC header, where the n bits of signalling are user-defined, where the positions of the n of m bits in the Duration/ID field are user-defined and may be contiguous or not.

Referring to FIG. 7, in step 701, a value stored in a Duration/ID field in an IEEE 802.11 MAC header is identified. For example, if the decimal value stored in the Duration/ID field is 1234 (i.e., binary value “0000010011010010”), then in terms of a NAV for the Duration/ID field, decimal value 1234 represents a time period of 1234 microseconds.

In step 703, n bits of signalling replace n of m bits of the Duration/ID field, where the n bits of signalling are user-defined, where n≦m, and where the positions of the n of m bits are user-defined. For example, if n is 2 and the 2 signalling bits are “01” and LSBs, then the value in the Duration/ID field (i.e., “0000010011010010”) becomes “0000010011010001,” (i.e., decimal value 1233), which in terms of a NAV represents 1233 microseconds.

In step 705, the IEEE 802.11 MAC header that includes the n signalling bits in the Duration/ID field is transmitted. Such a transmission improves WLAN spectrum efficiency by increasing the amount of signalling that may be transmitted in an IEEE 802.11 MAC header by n bits. Since the increased signalling is contained within one IEEE 802.11 MAC header, which is transmitted in one OSI layer, no cross-layer issues are introduced by the method. In addition, the IEEE 802.11 MAC header with the n additional signalling bits per the present invention is backward compatible with IEEE 802.11 MAC headers of other WLANs that do not include signalling bits per the method of FIG. 7, if n is chosen appropriately (e.g. n=2).

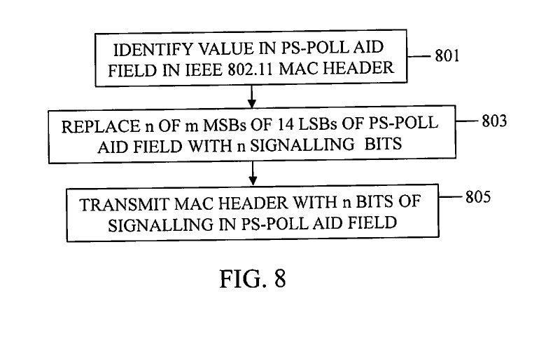

FIG. 8 is a flowchart of a method of an embodiment of the present invention, where n bits (e.g., 2 bits) of signalling replace n of m MSBs (e.g., bits 12 and 13, in this case n=m) of the 14 LSBs of a PS-Poll AID field in an IEEE 802.11 MAC header, where n≦m≦3, where the n bits of signalling are user-defined, where the positions of the n of m bits are user-defined and may be contiguous or not.

Referring to FIG. 8, in step 801, a value stored in a PS-Poll AID field in an IEEE 802.11 MAC header is identified. For example, the decimal value stored in the 14 LSBs of the PS-Poll AID field is 1234 (i.e., binary value “00010011010010”). The value stored in a PS-Poll AID field represents a value for an AID.

In step 803, n (e.g., 2) signalling bits replace n of m MSBs (e.g., bits 12 and 13) of the 14 LSBs of the PS-Poll AID field, where the positions of the n of m MSBs are user-defined, where n≦m, and where the n bits of signalling are user-defined. For example, if n=m=2 and the signalling bits are “01”, then the 14 LSBs of the PS-Poll AID field (i.e., “00010011010010”) becomes “01010011010010” (i.e., decimal value 5530), where the AID perceived by legacy devices is either 1234 or 5330, and the AID perceived by next generation devices is 1234.

In step 805, the IEEE 802.11 MAC header that includes n (e.g., 2) signalling bits in the PS-Poll AID field is transmitted. Such a transmission improves WLAN spectrum efficiency by increasing the amount of signalling that may be transmitted in an IEEE 802.11 MAC header by n bits (e.g. 2 bits). Since the increased signalling is contained within one IEEE 802.11 MAC header, which is transmitted in one OSI layer, no cross-layer issues are introduced by the method. In addition, the IEEE 802.11 MAC header with the 2 additional signalling bits is backward compatible with IEEE 802.11 MAC headers of other WLANs that do not include signalling bits per the present invention.

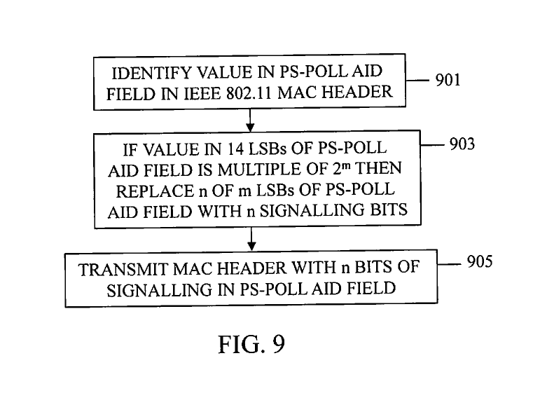

FIG. 9 is a flowchart of a method of an embodiment of the present invention, where n bits (e.g. 2 bits) of signalling replace n of m LSBs (e.g. the 2 LSBs, in this case n=m=2) of a PS-Poll AID field in an IEEE 802.11 MAC header if the value in the 14 LSBs of the PS-Poll AID field, before replacement by the n signalling bits (e.g., 2 bits), is a multiple of 2^{m}, where n≦m, where the n bits of signalling are user-defined, where the positions in the n of m LSBs are user-defined and may be contiguous or not.

Referring to FIG. 9, in step 901, a value stored in a PS-Poll AID field in an IEEE 802.11 MAC header is identified. For example, the decimal value stored in the 14 LSBs of the PS-Poll AID field is 1232 (i.e., binary value “00010011010000”). The value stored in a PS-Poll AID field represents a value for an AID.

In step 903, n bits (e.g. 2 bits) of signalling replace n of m LSBs of the PS-Poll AID field (e.g., the 2 LSBs) if the value in the 14 LSBs PS-Poll AID field, before replacement by the n bits (e.g. 2 bits) of signalling, is a multiple of 2^{m}, where n≦m, where the positions of the n of m LSBs are user-defined, and where the n bits of signalling are user-defined. For example, if the 2 signalling bits are “01” and the positions in the PS-Poll AID field replaced by the 2 signalling bits are the 2 LSBs, then the 14 LSBs of the PS-Poll AID field (i.e., “00010011010000”) become “00010011010001” (i.e., decimal value 1233), where the AID perceived by legacy devices is either 1232 or 1233, and the AID perceived by next generation devices is 1232.

In step 905, the IEEE 802.11 MAC header that includes n (e.g. 2) signalling bits in the PS-Poll AID field is transmitted. Such a transmission improves WLAN spectrum efficiency by increasing the amount of signalling that may be transmitted in an IEEE 802.11 MAC header by n bits (e.g., 2 bits). Since the increased signalling is contained within one IEEE 802.11 MAC header, which is transmitted in one OSI layer, no cross-layer issues are introduced by the method. In addition, the IEEE 802.11 MAC header with the n (e.g. 2) additional signalling bits is backward compatible with IEEE 802.11 MAC headers of other WLANs that do not include signalling bits per the present invention.

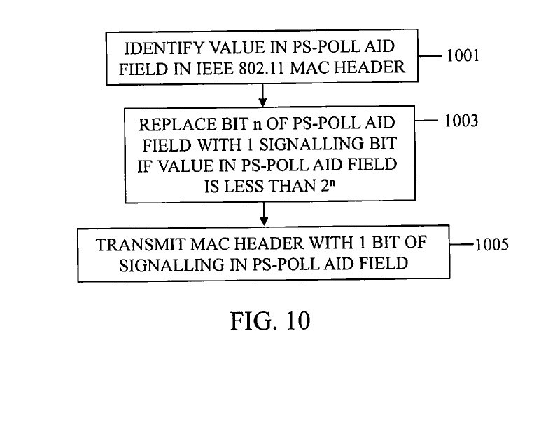

FIG. 10 is a flowchart of a method of an embodiment of the present invention, where 1 bit of signalling replaces bit n of a PS-Poll AID field in an IEEE 802.11 MAC header if the value of the 14 LSBs of the PS-Poll AID field, before replacement by the 1 bit of signalling, is less than 2ⁿ (e.g. 1024), where the 1 bit of signalling is user-defined, and where n is user-defined.

Referring to FIG. 10, in step 1001, a value stored in a PS-Poll AID field in an IEEE 802.11 MAC header is identified. For example, the decimal value stored in the 14 LSBs of the PS-Poll AID field is 208 (i.e., binary value “00000011010000”). The value stored in a PS-Poll AID field represents a value for an AID.

In step 1003, 1 bit of signalling replaces bit n (e.g. bit 10) of the PS-Poll AID field if the value in the 14 LSBs of the PS-Poll AID field, before replacement by the 1 bit of signalling, is less than 2ⁿ (e.g. 1024), where the 1 bit of signalling is user-defined, and where n is user-defined. For example, if the signalling bit is “1,” then the 14 LSBs of the PS-Poll AID field (i.e., “00000011010000”) becomes “00010011010000” (i.e., decimal value 1232), where the AID perceived by legacy devices is 1232, and the AID perceived by next generation devices is 208.

In step 1005, the IEEE 802.11 MAC header that includes 1 signalling bit in the PS-Poll AID field is transmitted. Such a transmission improves WLAN spectrum efficiency by increasing the amount of signalling that may be transmitted in an IEEE 802.11 MAC header by 1 bit. Since the increased signalling is contained within one IEEE 802.11 MAC header, which is transmitted in one OSI layer, no cross-layer issues are introduced by the method. In addition, the IEEE 802.11 MAC header with the 1 additional signalling bit is backward compatible with IEEE 802.11 MAC headers of other WLANs that do not include signalling bits per the present invention.

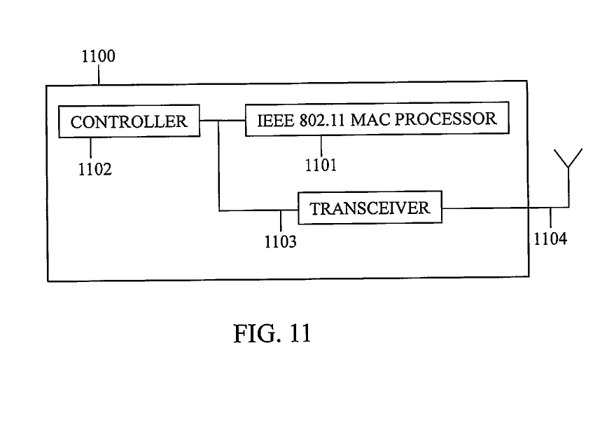

FIG. 11 is a schematic block diagram of an apparatus of a station 1100 of the present invention.

Referring to FIG. 11, the station 1100 includes an IEEE 802.11 MAC processor 1101, a controller 1102, a transceiver 1103, and an antenna 1104.

The IEEE 802.11 MAC processor 1101 contains and processes a MAC header in accordance with the IEEE 802.11 standard, where the MAC header includes either a Duration/ID field or a PS-Poll AID field.

In an embodiment of the present invention, the controller 1102 is configured to control the IEEE 802.11 MAC processor 1101 to modify a MAC header in the IEEE 802.11 MAC processor 1101 by adding a decimal value k to a Duration/ID field in the IEEE 802.11 MAC header and replacing n of m Least Significant Bits (LSBs) of the Duration/ID field with n bits of signalling, where n≦m, where the positions of the n of m bits are user-defined and may be contiguous or not, and where the n bits of signalling are user-defined.

In another embodiment of the present invention, the controller 1102 is configured to control the IEEE 802.11 MAC processor 1101 to modify the MAC header in the IEEE 802.11 MAC processor 1101 by n bits of signalling replacing n of m bits of a Duration/ID field in the IEEE 802.11 MAC header, depending on how the value of the n bits of signalling compares to the value of the m LSBs of the Duration/ID field, where n≦m, where the n bits of signalling are user-defined, and where the positions of the n of m bits of the Duration/ID field are user-defined and may be contiguous or not. If the decimal value of the n bits of signalling is less than the decimal value of the n LSBs of the Duration/ID field in a case where n=m, then a decimal value k is added to the decimal value of the Duration/ID field and the n LSBs of the sum are replaced with the n bits of signalling. An example of a decimal value for k is the decimal value 4 (i.e., binary “10”). If the decimal value of the n bits of signalling is greater than the decimal value of the n LSBs of the Duration/ID field, then the n LSBs of the Duration/ID field are replaced with the n bits of signalling. See FIG. 6 described above for an example where n≠m.

In another embodiment of the present invention, the controller 1102 is configured to control the IEEE 802.11 MAC processor 1101 to modify the MAC header in the IEEE 802.11 MAC processor 1101 by n bits of signalling replacing n of m bits (e.g., n LSBs) of a Duration/ID field in the IEEE 802.11 MAC header, where n≦m, where the n bits of signalling are user-defined, and where the positions of the n of m of the Duration/ID field are user-defined.

In another embodiment of the present invention, the controller 1102 is configured to control the IEEE 802.11 MAC processor 1101 to modify the MAC header in the IEEE 802.11 MAC processor 1101 by n bits (e.g. 2 bits) of signalling replacing n of m MSBs of the 14 LSBs of a PS-Poll AID field in the IEEE 802.11 MAC header, where the n bits of signalling are user-defined, where n≦m≦3, and where the positions of the n of m of the PS-Poll AID field are user-defined and may be contiguous or not.

In another embodiment of the present invention, the controller 1102 is configured to control the IEEE 802.11 MAC processor 1101 to modify the MAC header in the IEEE 802.11 MAC processor 1101 by n bits (e.g. 2 bits) of signalling replacing n of m LSBs (e.g. the 2 LSBs) of a PS-Poll AID field in the IEEE 802.11 MAC header if the value in the 14 LSBs of the PS-Poll AID field is a multiple of 2^{m}, before replacement by the n (e.g. 2) signalling bits, where the n bits of signalling are user-defined, where n≦m, and where the positions of the n of m in the PS-Poll AID field are user-defined and may be contiguous or not.

In another embodiment of the present invention, the controller 1102 is configured to control the IEEE 802.11 MAC processor 1101 to modify the MAC header of the IEEE 802.11 MAC processor 1101 by 1 bit of signalling replacing bit n (e.g. bit 10) of a PS-Poll AID field in the IEEE 802.11 MAC header if the value of the 14 LSBs of the PS-Poll AID field is less than 2ⁿ, before replacement by the signalling bit, where the 1 bit of signalling is user-defined, and where the position of bit n of the PS-Poll AID field is user-defined.

The transceiver 1103 transmits an IEEE 802.11 MAC header that includes one or more signalling bits replaced therein by the IEEE 802.11 MAC processor 1101 under control of the controller 1102 via the antenna 1104.

The present invention may also be implemented as computer readable codes in a non-transitory computer readable recording medium. The non-transitory computer readable recording medium is a data storage device for storing data read by a computer system. For example, the non-transitory computer readable recording medium includes a Read-Only Memory (ROM), a Random Access Memory (RAM), a Compact Disc (CD) ROM, a magnetic tape, a floppy disk, an optical data storage device, and a carrier wave (i.e., a transmission of data through the Internet). The non-transitory computer readable recording medium may be distributed through computer systems connected to a network, and thus, the computer readable code may be stored and executed in a distributed manner. Further, functional programs, codes, and code segments for establishing the present invention may easily be interpreted by programmers skilled in the art to which the present invention is applied.

Accordingly, the present invention includes a program including a code for implementing the apparatus and methods described in the appended claims of this specification and a non-transitory machine (a computer or the like)-readable storage medium for storing the program. Further, the program may be electronically transferred by a predetermined medium such as a communication signal transferred through a wired or wireless connection, and the present invention appropriately includes equivalents of the program.

A portable terminal according to the embodiments of the present invention may receive the program from a program providing device that is wiredly or wirelessly connected with the portable terminal, and may store the program. The program providing device may include a program including instructions through which a graphic processing apparatus implements a preset content protection method, a memory for storing information or the like required for the content protecting method, a communication unit for performing wired or wireless communication with the graphic processing apparatus, and a controller for transmitting the corresponding program to a transceiver according to a request of the graphic processing apparatus or automatically.

Although embodiments of the present invention have been described in the detailed description of the present disclosure, the present invention may be modified in various forms without departing from the scope of the present invention. Thus the scope of the present invention shall not be determined merely based on the described embodiments, but rather determined based on the accompanying claims and equivalents thereto.

What is claimed is:

1. A method of transmitting signalling in a field of a header, comprising:
identifying the field of the header;
replacing n bits in the field with n signalling bits, where positions in the field replaced by the n signalling bits are contiguous or non-contiguous, and where the n signalling bits and the positions in the field are user-defined; and
transmitting the header.

2. The method of claim 1, wherein the header is an Institute of Electrical and Electronics Engineers (IEEE) 802.11 Medium Access Control (MAC) header.

3. The method of claim 2, wherein the field is a Duration/Identification (Duration/ID) field.

4. The method of claim 3, wherein replacing n bits in the field with n signalling bits comprises:
adding k to the field; and
replacing n of m Least Significant Bits (LSBs) of the field with n signalling bits, where n≦m and k is 2^{m}.

5. The method of claim 4, wherein k is 4 and n and m are each 2.

6. The method of claim 3, wherein replacing n bits in the field with n signalling bits comprises:
determining if n bits of signalling replacing n of m Least Significant Bits (LSBs) of the field results in a higher or lower value of the LSBs, where n≦m;
if replacement by n bits of signalling results in a lower value of the LSBs, then adding k to the field, where k is 2^{m}, and replacing the n of m LSBs of the field with the n bits of signalling; and
if replacement by the n bits of signalling results in a higher value of the LSBs, then replacing the n of m LSBs of the field with the n bits of signalling.

7. The method of claim 6, wherein k is 4 and n and m are each 2.

8. The method of claim 3, wherein replacing n bits in the field with n signalling bits comprises inserting n signalling bits into n of m Least Significant Bits (LSBs) of the field, where n≦m.

9. The method of claim 8, wherein n and m are each 2.

10. The method of claim 3, wherein the n replaced bits are each treated as 0 for determining a Duration and are, otherwise, treated as signalling bits.

11. The method of claim 2, wherein the field is a PS-Poll Association Identifier (AID) field.

12. The method of claim 11, wherein replacing n bits in the field with n signalling bits comprises inserting n signalling bits into n of in Most Significant Bits (MSBs) of fourteen Least Significant Bits (LSBs) of the field, respectively, where n≦m≦3.

13. The method of claim 11, wherein replacing n bits in the field with n signalling bits comprises n signalling bits replacing n of m Least Significant Bits (LSBs) of the field if a value of fourteen LSBs of the field is a multiple of 2^{m}, where n≦m.

14. The method of claim 11, wherein replacing n bits in the field with n signalling bits comprises a signalling bit replacing a bit n of the field if a value in fourteen Least Significant Bits (LSBs) of the field is less than 2ⁿ, where counting of the bits starts at 0.

15. The method of claim 13, wherein the AID is a multiple of 2^{m}.

16. The method of claim 14, wherein the AID is less than 2ⁿ.

17. The method of claim 11, wherein the n replaced bits are each treated as 0 for determining a PS-Poll Association Identifier (AID) and are, otherwise, treated as signalling bits.

18. The method of claim 12, wherein n and m are each 2.

19. The method of claim 13, wherein n and m are each 2.

20. The method of claim 14, wherein n is 2.

21. An apparatus for transmitting signalling in a field of a header, comprising:
a processor configured to identify the field of the header;
a controller configured to replace n bits of the field with n signalling bits, where positions in the field replaced by the n signalling bits are contiguous or non-contiguous, and where the n signalling bits and the positions in the field are user-defined; and
a transceiver configured to transmit the header.

22. The apparatus of claim 21, wherein the header is an Institute of Electrical and Electronics Engineers (IEEE) 802.11 Media Access Control (MAC) header.

23. The apparatus of claim 22, wherein the field is a Duration/Identification (Duration/ID) field.

24. The apparatus of claim 23, wherein the controller is further configured to:
add k to the field; and
replace n of m Least Significant Bits (LSBs) of the field with n signalling bits, where n≦m and k is 2^{m}.

25. The apparatus of claim 24, wherein k is 4 and n and m are each 2.

26. The apparatus of claim 23, wherein the controller is further configured to
determine if n bits of signalling replacing n of m Least Significant Bits (LSBs) of the field results in a higher or lower value of the LSBs, where n≦m;
if replacement by the n bits of signalling results in a lower value of the LSBs, then adding k to the field, where k is 2^{m}, and replacing the n of m LSBs of the field with the n bits of signalling; and
if replacement by the n bits of signalling results in a higher value of the LSBs, then replacing the n of m LSBs of the field with the n bits of signalling.

27. The apparatus of claim 26, wherein k is 4 and n and m are each 2.

28. The apparatus of claim 23, wherein the controller is further configured to replace n of m Least Significant Bits (LSBs) of the field with n signalling bits, where n≦m.

29. The apparatus of claim 28, wherein n and m are each 2.

30. The apparatus of claim 23, wherein the n replaced bits are each treated as 0 for determining a Duration and are, otherwise, treated as signalling bits.

31. The apparatus of claim 26, wherein the field is a PS-Poll Association Identifier (AID) field.

32. The apparatus of claim 31, wherein the controller is further configured to replace n of m Most Significant Bits (MSBs) of fourteen Least Significant Bits (LSBs) of the field with n signalling bits, respectively, where n≦m≦3.

33. The apparatus of claim 31, wherein the controller is further configured to replace n of m Least Significant Bits (LSBs) of the field with n signalling bits if a value of fourteen LSB of the field is a multiple of 2^{m}, where n≦m.

34. The apparatus of claim 31, wherein the controller is further configured to replace bit n of the field with a signalling bit if a value in fourteen Least Significant Bits (LSBs) of the field is less than 2ⁿ, where counting of the bits starts at 0.

35. The apparatus of claim 33, wherein the AID is a multiple of 2^{m}.

36. The apparatus of claim 34, wherein the AID is less than 2ⁿ.

37. The apparatus of claim 31, wherein the n replaced bits are each treated as 0 for determining a PS-Poll Association Identifier (AID) and are, otherwise, treated as signalling bits.

38. The apparatus of claim 32, wherein n and m are each 2.

39. The apparatus of claim 33, wherein n and m are each 2.

40. The apparatus of claim 34, wherein n is 2.

41. A non-transitory computer-readable recording medium having recorded thereon a program for transmitting signalling in a field of a header, the program, when executed by a computer, causes the computer to perform a method, the method comprising:
identifying the field of the header;
replacing n bits in the field with n signalling bits, where positions in the field replaced by the n signalling bits are contiguous or non-contiguous, and where the n signalling bits and the positions in the field are user-defined; and
transmitting the header.
